(19) United States
(12) Patent Application Publication
(10) Pub. No.: US 2011/0033350 A1
(43) Pub. Date: Feb. 10, 2011

(54) PROCESS FOR RECOVERING SUBSTANCES FROM HIGH SALINITY LIQUIDS

(75) Inventor: Solomon Flaks, Jerusalem (IL)

Correspondence Address: OLIFF & BERRIDGE, PLC, P.O. BOX 320850, ALEXANDRIA, VA, 22320-4850, US

(73) Assignee: ECOCHEM TECH, LTD., Tzemach Jordan Valley (IL)

(21) Appl. No.: 12/672,199

(22) PCT Filed: Aug. 10, 2008
(86) PCT No.: PCT/IL08/01100

§ 371 Date: Feb. 4, 2010

Related U.S. Application Data
(60) Provisional application No. 60/954,871, filed on Aug. 9, 2007.

(51) Int. Cl. C01F 11/18; B01J 8/00

(52) U.S. Cl. 423/165; 422/187

(57) ABSTRACT

The present disclosure provides a process for recovering from high salinity liquid a substance comprising a selected alkaline earth carbonate salt, the process comprises (i) adding to said high salinity liquid a reagent comprising a solution of an alkali metal carbonate in an amount sufficient to allow precipitation of said substance in said liquid, while continuously introducing into the liquid a gas whereby a high degree of precipitate is formed in the liquid; and (ii) isolating said precipitate from the liquid, wherein said precipitate comprising the alkaline earth carbonate comprising substance in an essentially purified form (at least 95% w/w degree of purity). Also provided are a unit and a system constructed and operative for performing the process, preferably continuously.

### FIELD OF THE INVENTION

This invention relates to water treatment processes and in particular, to processes for recovering from high salinity liquids substances.

### BACKGROUND OF THE INVENTION

Sea water is a valuable and inexhaustible source of useful minerals, since it contains all the elements existing on earth in the form of salts and other compounds. However, because of the low content of most elements, their industrial extraction from sea water is not carried out. A number of studies were conducted on extracting various metals from sea water by means of ion exchangers or extraction processes, however, these are not utilized, probably, due to low effectiveness and high cost.

At present, on an industrial scale magnesium oxide, common salt (NaCl), and potassium chloride (KCl) are produced from sea water. Rare and dispersed elements are not extracted, and any produced magnesium hydroxide comprises other elements, such as CaSO₄; SiO₂; Fe(OH)₂, and others. After incinerating such magnesium hydroxide at a temperature of ≧800° C., a product of ≦95% MgO is obtained, typically used only for the production of fire-proof bricks.

To produce high-purity magnesium containing compounds, such as magnesium hydroxide, magnesium carbonate, basic magnesium carbonate (Magnesia Alba) that are used in the production of plastics, rubber, pharmaceuticals, food additives, and in other fields, the magnesium based extracted compounds is typically dissolved in acid and thereafter precipitated to obtained purified magnesium-based compounds are precipitated. Such treatment steps considerably increase the cost for extracting magnesium based compounds from salinated fluids.

A process producing magnesium oxide from sea water, brine or from production wastes of potassium salts was previously described by P. P. Budnikov, (Chemical Technology of Ceramics and Refractory Materials, ed. by P. P. Budnikov et al., Moscow, Stroitel'stvo Publishers, 1972, pp. 126-128, 312, 317-318 with English translation). This method consisted of acidification of brine with calcium bicarbonate followed by the addition of calcium chloride so as to convert magnesium sulfate into magnesium chloride. In each step magnesium remained in solution and the precipitate was filtered out. Finally calcinated and hydrated dolomite or lime resulted in the precipitation and isolation of magnesium hydroxide with a purity of no more than 95%.

Other industrial processes that use dolomite yielded impure magnesium hydroxide, namely, an admixture of the magnesium hydroxide with insoluble substances.

In U.S. Pat. No. 7,261,912 a method is described for making products, such as fertilizers and food additives, from sea water and from similar brines, by joint precipitation of magnesium hydroxide (Mg(OH)₂), calcium carbonate (CaCO₃) and ferric hydroxides, as well as hydroxides of aluminum and of heavy metals. The precipitation utilizes a pH=10.75-11.0 by using NaOH or KOH at equimolar proportions and of soda ash (Na₂CO₃) or of carbonates of other alkali metals typically used for precipitation of calcium.

Further, Irving L published data relating to the precipitation of hydroxides and carbonates of calcium and of magnesium from sea water at 16° C. [J. Marine Biological Association 14(2):441-446 (1926)]. The data teaches that precipitation of calcium and magnesium using NaOH at pH=11.6 where about 57% of the calcium existing and 86% of magnesium in the seawater precipitated.

A system and method for producing elemental magnesium (Mg) from seawater is described in U.S. Pat. No. 6,267,854. The system and method make use of electric current between an anode and cathode in order to separate between positive and negative ions. The electric charge associated with the cathode causes the seawater to decompose into H₂ and (OH⁻)₂ and positively charged magnesium ions thereby combine with the (OH⁻)₂ to form magnesium hydroxide precipitates.

Finally, a method of producing basic magnesium carbonate represented by the following general formula: nMgCO₃.Mg(OH)₂.mH₂O (n is a number of from 3 to 5 and m is a number of from 3 to 5) is described in U.S. Pat. No. 5,240,692.

### SUMMARY OF THE INVENTION

An object of the present disclosure is to provide processes for removing from high salinity liquids, such as seawater, brine, brackish water and other salt or salinated water, substances, at relatively high degree of purity. Such substances include carbonate salts and hydrates of carbonate salts.

Thus, in accordance with one aspect, there is provided a process for removing from high salinity liquid a substance comprising a desired alkaline earth carbonate, the process comprising:

(i) adding to high salinity liquid a reagent comprising a solution of an alkali metal carbonate while continuously introducing into the liquid a gas, the amount of said reagent being sufficient to allow precipitation of said substance in said liquid;

(ii) isolating precipitated substance from the liquid, said precipitated substance comprising the desired alkaline earth carbonate.

In accordance with another aspect, there is provided a treatment unit for recovery from high salinity liquid a substance comprising an alkaline earth carbonate, the treatment unit comprising:
a liquid treatment module adapted for holding high salinity liquid and provided with an assembly for agitating the liquid held in said module;
an assembly for introducing a reagent comprising a solution of alkali metal carbonate into the liquid held in said treatment module;
an assembly for introducing gas into the liquid held in said treatment module;
an assembly for withdrawing liquid containing precipitated substance;
an assembly for separating precipitate from liquid.

A further aspect in accordance with the present disclosure relates to a system for removing from high salinity liquid a substance comprising an alkaline earth carbonate, the system comprising a plurality of treatment modules as disclosed herein, each module being operated for precipitating and withdrawing from the liquid a different substance, the system comprising a control unit for controlling at least the operation of each treatment module.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram illustrating a multi-stage process for recovering from high salinity liquid different substances in accordance with an embodiment of the present disclosure.

FIG. 2 is a simplified schematic illustration of a treatment unit constructed and operative in accordance with an embodiment of the present disclosure.

FIG. 3 is a simplified schematic illustration of a treatment system comprising a plurality of the treatment modules illustrated in FIG. 2, constructed and operative in accordance with an embodiment of the present disclosure.

### DETAILED DESCRIPTION OF THE INVENTION

The disclosed technology stems from the development of a simple and cost efficient process for recovering substances from high salinity liquid, such as brine from desalination plants. Specifically, the process permits a sequential, step-by-step process for recovery of various substances from high salinity liquid, each being obtained at an essentially purified form (>90% w/w, preferably >95% w/w).

Thus, in accordance with a first of its aspects, there is provided a process for recovering from high salinity liquid a substance comprising a desired, selected, pre-determined alkaline earth carbonate, the process comprising:

(i) adding to said high salinity liquid a reagent comprising a solution of a alkali metal carbonate in an amount sufficient to allow precipitation of said substance in said liquid, while continuously introducing into the liquid a gas;

(ii) isolating said precipitated substance from the liquid, wherein said precipitated substance comprises the desired alkaline earth carbonate. The isloated alkaline earth carbonate is obtained in an essentially purified form.

As used herein, the term “high salinity liquid” denotes any liquid having a salt content of at least about 1000 ppm of total dissolved salts (TDS), and more preferably more than about 10,000 ppm TDS. Without being bound thereto, the high salinity liquid salinated water (water with the above defined lower limit of dissolved salts), such as seawater from seas, e.g. Gulf, Red Sea, Mediterranean and Oceans, water from various salt lakes and ponds, high brackish water sources, brines, contaminated water from industrial and home waste liquids and other surface and subterranean sources of water having ionic contents, which classify them as saline.

It is appreciated that high salinity liquid, such as seawater comprise a mixture of various alkaline earth metals (Mg, Ba, Sr, Ca), heavy metals and other elements. It has now been envisages that by a sequential process, each process step (or two or more sequential steps) may allow the isolation of a carbonate salt of alkaline earth metals. These carbonate salts may be obtained in accordance with the present disclosure at an essentially high degree of purity (e.g. above 90% w/w, 95% w/w and even more than 99% w/w). Thus, in the context of the present disclosure, the term “high salinity liquid” denotes a liquid comprising at least one of magnesium chloride, calcium chloride, chlorides of alkaline metals etc., which may be, by the present teaching, “converted” to carbonate salts and isolated.

The term “liquid” as used herein denotes any water containing medium.

The term “substance comprising alkaline earth carbonate” (also referred to at times as “substance”) is used herein to denote any molecule comprising at least one alkaline earth carbonate (metal) salt. Without being limited thereto, the substance may include Sr₂CO₃, BaCO₃, Ca₂CO₃, hydrates of MgCO₃ such as xMgCO₃.yMg(OH)₂.zH₂O wherein x, y and z, which may be the same or different numbers, represent stoichiometric coefficients. The substance having the general formula xMgCO₃.yMg(OH)₂.zH₂O may include, without being limited thereto, any hydrated form of MgCO₃, such as, 4MgCO₃.Mg(OH)₂.5H₂O (known as Magnesia Alba Levis), or MgCO₃.Mg(OH)₂.4H₂O (known as Magnesia Alba Ponderosa), or 3MgCO₃.Mg(OH)₂.3H₂O (known as Magnesia Alba). It is noted that the term may include a combination of alkaline earth metal carbonates. Such combinations will typically include a single carbonate in majority over any other carbonates in the combination.

A “selected substance” or “selected alkaline earth carbonate” is used herein to denote a substance or alkaline earth carbonate salt the recovery of which from the liquid is sought. Thus, when referring to a process for the recovery of a selected substance/alkaline earth carbonate salt it is intended that the process to be utilized makes use of conditions pre-determined and suitable for the precipitation and thereby removal from high salinity liquid of a particular substance/alkaline earth carbonate salt. Some non-limiting parameters which may dictate the precipitation and thereby removal of a selected substance/alkaline earth carbonate salt from high salinity liquid are listed below. Those versed in the art will readily appreciate additional parameters dictating precipitation of alkaline earth carbonate salts in aqueous medium.

The term “precipitate” or “precipitated substance” as used herein refers to the formation in the conditions set in the liquid (pH, temperature etc.) of at least one insoluble alkaline earth carbonate salt.

The term “heavy metals” as used herein refers to metal elements having an atomic number of at least 22 including but not limited to copper, nickel, cadmium, cobalt, indium, tin, lead, mercury, antimony, arsenic, bismuth, and thallium.

The term “precious metals” as used herein refers to rare metallic chemicals that are highly valued economically by consumers. The best appreciated precious metals are gold and silver. Other precious metals include the platinum group metals: ruthenium, rhodium, palladium, osmium, iridium and platinum. Rhenium is also regarded as a precious metal.

The term “alkali metal carbonate” denotes any substance comprising alkali metal carbonate and which can react with one or more of the alkaline earth ions in the high salinity liquid to form an alkaline earth carbonate or a substance comprising alkaline earth carbonate. In accordance with one embodiment of the invention, the alkali metal carbonate is Na₂CO₃, in other embodiments the alkali metal carbonate are K₂CO₃, Li₂CO₃, Rb₂CO₃ or Cs₂CO₃.

The term “gas” as used herein denotes any gas that can be dissolved in the liquid. The gas is preferably an inert gas, such as, without being limited thereto, oxygen, nitrogen, air, etc. The gas in the context of the present disclosure will not include an amount of CO₂ greater than that contained in air. In other words, the amount of CO₂, if present in the gas to be employed in the context of the present disclosure shall not be more than 0.05% v/v (equivalent to 500 ppm). The gas is used to cause turbulence in the liquid and to facilitate a shift in the reaction equilibrium towards the formation of the desired carbonate, by causing dissolved CO₂ to be expelled from the liquid. In accordance with one embodiment, the gas is air.

The gas may be introduced into the high salinity liquid by any means which permits dissolution of the gas in the liquid. In one embodiment, the gas is bubbled into the liquid, in another embodiment; the gas is introduced by the use of an air compressor or high pressure fluid jet.

The gas is introduced into the liquid so as to cause agitation of the liquid. The terms “agitation”, or “agitating” as used herein, includes any form of turbulence caused in the liquid. If necessary, agitation may also be facilitated by the aid of suitable agitation means, such as a suitable stirrer.

The solution of alkali metal carbonate, namely, the reagent, may be prepared by dissolution of the salt in an aqueous medium. While the aqueous medium may be pure or purified water, it is economically advantageous to use salted or salinated liquid recovered from the process disclosed herein. Thus, in accordance with one embodiment, the process provides, in addition to the recovered alkaline earth carbonate, treated liquid. This treated liquid may then be utilized for producing the solution of alkali metal carbonate. The term “treated liquid” denotes a liquid from which at least one substance including alkaline earth carbonate has been removed. The treated liquid typically includes one or more chloride salts, such as NaCl. Thus, the amount of alkali metal carbonate to be dissolved in the treated liquid depends on the amount of such chloride salts in the liquid and the solubility coefficient of the salts, so as to reach optimal (e.g. maximal) dissolution of the carbonate in the liquid. The alkali metal carbonate dissolved in the treated liquid thus forms the stock “solution of alkali metal carbonate” or, as also termed herein, “a reagent”, which is to be introduced into the high salinity liquid. As an example only, when using a treated liquid comprising 6.4% w/w of NaCl, 25.1% w/w of Na₂CO₃ can be dissolved at 25° C. to form the reagent solution. In other words, 266 kg of Na₂CO₃ can be dissolved in 1 m³ of such treated liquid

The amount of reagent, namely, the stock solution of alkali metal carbonate to be introduced into the high salinity liquid may vary depending on the composition of the high salinity liquid to be treated and the conditions under which the process is performed. The amount should be greater than that required, at least according to stoichometric calculations, to completely react with the alkaline earth metal and thereby cause precipitation in the liquid. The parameters that may be taken into consideration for calculating the amount of reagent to be introduced, include, without being limited thereto, pH of the liquid, temperature of the liquid, concentration in the liquid of the alkaline earth metal carbonate to be recovered in the liquid, solubility coefficient of the alkaline earth metal carbonate to be recovered, concentration of the alkali metal carbonate in the solution, etc. Those versed in the art will readily identify the parameters associated with alkaline earth carbonate formation in the presence of dissolved Na₂CO₃.

As indicated hereinbefore, the alkali metal carbonate is Na₂CO₃, although other alkali metal carbonates may be employed, e.g. K₂CO₃, Li₂CO₃, Rb₂CO₃ or Cs₂CO₃.

The alkaline earth carbonate to be recovered may be, without limited thereto, one or more of the following SrCO₃, BaCO₃, FeCO₃, CaCO₃, hydrates of MgCO₃ such as xMgCO₃.yMg(OH)₂.zH₂O, wherein x, y and z represent stoichiometric coefficients. In accordance with one embodiment, namely under selected process conditions(hereinafter 1^{st} process conditions, or 1^{st} treatment), the substance comprising alkaline earth' carbonate includes an admixture of SrCO₃, BaCO₃, FeCO₃. In another embodiment, (hereinafter 2^{nd} process conditions, or 2^{nd} treatment) the substance comprises CaCO₃; in yet another embodiment, (hereinafter 3^{rd} process conditions, or 3^{rd} treatment) the substance comprises 3MgCO₃.Mg(OH)₂.3H₂O. The conditions for selective precipitation in accordance with the 1^{st}, 2^{nd} or 3^{rd} process conditions are described hereinafter.

In accordance with the process disclosed herein, the recovered substance is obtained with a high degree of purity. The term “high degree of purity” used interchangeably with the term “essentially purified” is used herein to denote a substance comprising at least 90% (w/w) of one or more alkaline earth carbonate. In an alternative embodiment, the term denotes a substance comprising at least 95% of the one or more alkaline earth carbonate. In yet another alternative embodiment, the term denotes a substance comprising at least 99% of the one or more alkaline earth carbonate. In one embodiment, the substance comprises a high percentage of a single alkaline earth carbonate salt.

The process disclosed herein may include a pre-treatment step of the high salinity liquid before an alkaline earth carbonate is removed. The pre-treatment step is utilized to remove one or more metals, typically, precious and heavy metals, from the high salinity liquid and includes subjecting the liquid to electrolysis. In accordance with a preferred embodiment, the electrolysis is carried out at a D.C. voltage equal or less than about 1.5V and at a current density equal or less than about 10 A/m². The selection of this voltage limit is essential in order to prevent electrolytic decomposition of alkali metal chlorides and alkali-earth chlorides in the liquid, which may result in the production of hazardous chloride gas.

The pre-treatment step may be effective to remove from the high salinity liquid one or more of the metals selected from the group consisting of Ag, Au, Cu, Ni, Co, Cd, In, Sn, Pb, Hg, As, Sb, Bi, Pd, Pt and Tl. This group of metals include precious metals that can then be utilized for industry etc., as appreciated by those versed in the art.

As also appreciated in an electrolytic processes, metals deposit on the cathode. The cathode therefore should be periodically removed for treatment so as to remove (strip) therefrom the precipitated heavy and precious metals. In one embodiment, the electrolytic pre-treatment step employs at least one cathode coated with a removable electric conducting material. The removable electric conducting material may comprise a fabric coated or impregnated with conducting material, such as conducting paint. The removable fabric may in due course, e.g. when deposited with the metals and requiring replacement, be washed with a suitable acid, decomposed, burned or treated in any other manner so as to recover the metal(s) from the conducting material. The use of a conducting coating material will save the labor-intensive and thus costly process of stripping the cathodes from the deposited metals.

In accordance with one embodiment, the substance comprising one or more alkaline earth carbonate preferably includes an admixture of SrCO₃, BaCO₃ and FeCO₃. For the recovery of this admixture, the process comprises the addition of an amount of the reagent sufficient to obtain a pH in said liquid equal or less than 8.7. It has been established that this pH upper limit will facilitate the selective precipitation of the aforementioned carbonates (1^{st} precipitated substance). The thus formed admixture may also comprise manganese hydroxide (Mn(OH)₂), Fe(OH)₂ as well as other metal hydroxides. To increase the amount of precipitated admixture it is preferable that the process is conducted at a temperature range of between about 25° C. and about 30° C.

It has been established that the introduction of air into the liquid while precipitated the admixture of Sr, Fe and Ba carbonates prevents the formation of bicarbonates of these metals, and thereby increase the yield of the process, namely, the percentage of the carbonate in the precipitated substance.

The amount of reagent introduced into the liquid in order to obtain optimum precipitation of the admixture (namely, maximal yield of recovery) is greater than the stoichometric equivalent by at least 0.1%.

In accordance with another embodiment (the so-called 2^{nd} process conditions), the substance to be recovered comprises CaCO₃ (2^{nd} precipitated substance). The CaCO₃ may be recovered from the high salinity liquid with or without a priori removal of the aforementioned admixture of SrCO₃, BaCO₃, FeCO₃. In a preferred embodiment, the CaCO₃ is recovered from a liquid after recovery therefrom of the admixture (the 1^{st} precipitated substance). The recovery of CaCO₃ also involves the addition into the liquid an amount of the solution of the alkali metal carbonate. The amount of the solution is determined, inter alia, to obtain a pH in said liquid in the range of between about 8.8 to about 9.0. This pH range was found to be optimal for selective precipitation of said CaCO₃. Optimally, the temperature of the liquid for precipitating CaCO₃ is greater than 20° C., preferably, equal or greater than 60° C.

In yet another embodiment (the 3^{rd} process conditions), the process is utilized for the precipitation and removal of a substance comprising hydrates of magnesium carbonate. Specifically, the hydrate of the general formula xMgCO₃.yMg(OH)₂.zH₂O is precipitated. A hydrate of magnesium carbonate of particular interest is 3MgCO₃.Mg(OH)₂.3H₂O, known as magnesia alba or basic carbonate magnesia.

The hydrate of magnesium carbonate thereof is preferably recovered from the liquid from which the carbonates of Fe, Ca, Ba and Sr has already been removed.

To precipitate hydrates of magnesium carbonate, the reagent is added to the liquid in an amount sufficient to obtain a pH in said liquid in the range of between about 9.5 to about 10.5 which facilitates precipitation of selective hydrates of magnesium carbonate. A preferred temperature for selective precipitation of hydrates of magnesium carbonate is equal or greater than 25° C., preferably, equal or greater than 60° C.

In one embodiment, the process disclosed herein is a multi-stage process where, several substances are selectively precipitated in sequence by repeating the process steps (i) and (ii) in sequence, each conducted under conditions suitable for precipitation and recovery of a different substance (the precipitation of a single substance being regarded as a “stage” in the multi-stage process). For example, the process may be conducted such that steps (i) and (ii) are repeated at least three times (1^{st} treatment/process conditions, 2^{nd} treatment/process conditions and 3^{rd} treatment/process conditions, respectively) for sequential precipitation in the 1^{st} treatment of a substance comprises one or more, preferably admixture, of alkaline earth carbonates selected from SrCO₃, BaCO₃, FeCO₃ (at a pH equal or less than 8.7 and at a temperature in the range of 25° C. to about 30° C., as detailed above); in the 2^{nd} treatment of a substance comprising CaCO₃ (at a pH between 8.8 and 9.0 and at a temperature greater than 20° C., as detailed above); and in the 3^{rd} treatment of a substance comprising hydrates of magnesium carbonate (at a pH of between about 9.5 to about 10.5 and at a temperature equal or greater than 25° C., as detailed above).

Each of the substances thus recovered are dried, e.g. by heating to a temperature of between 110° C.-120° C., optionally under vacuum conditions, and then are ready for commercial.

The present disclosure also provides a treatment unit for recovery from high salinity liquid a substance comprising an alkaline earth carbonate, the system comprising:
a liquid treatment module adapted for holding high salinity liquid and provided with an assembly for agitating the liquid held in said module;
an assembly for introducing a reagent comprising a solution of alkali metal carbonate into the liquid held in said treatment module;
an assembly for introducing gas into the liquid held in said treatment module;
an assembly for withdrawing liquid containing precipitated substances;
an assembly for separating precipitate from treated liquid.

In one embodiment, the gas assembly comprises a compressor for pressing said gas into liquid held in the module. It is noted that the introduction of pressed gas into the liquid causes turbulence and thereby mixing of the liquid.

Further disclosed herein is a system for recovery from high salinity liquid substances comprising an alkaline earth carbonate, the system comprising a plurality of treatment modules disclosed herein, each module being operated for precipitating and withdrawing a different selected substance, the system comprises a control unit for controlling the operation of each treatment module.

In one embodiment, the plurality of treatment modules are arranged in a series, such that liquid removed from one treatment module is conveyed into a following treatment module.

In yet another embodiment, the system operates in a continuous mode, thereby facilitating a continuous, on going, process for treating high salinity liquid.

In another embodiment, the system is constructed and operated such that liquid recovered after removal of the 1^{st}, 2^{nd} and 3^{rd} precipitated substances is used for preparation of the reagent. Thus, in other words, the system is operated as a closed circuit system.

According to one embodiment, the treatment unit preferably makes use of a Pachuca tank the function and operation of which is described by Shekhar R and Evans J. W. (Metallurgical Transactions B, Volume 20, Issue 6, pp. 781-791 (1989)). The system disclosed herein is thus constructed from a series of Pachuca tanks.

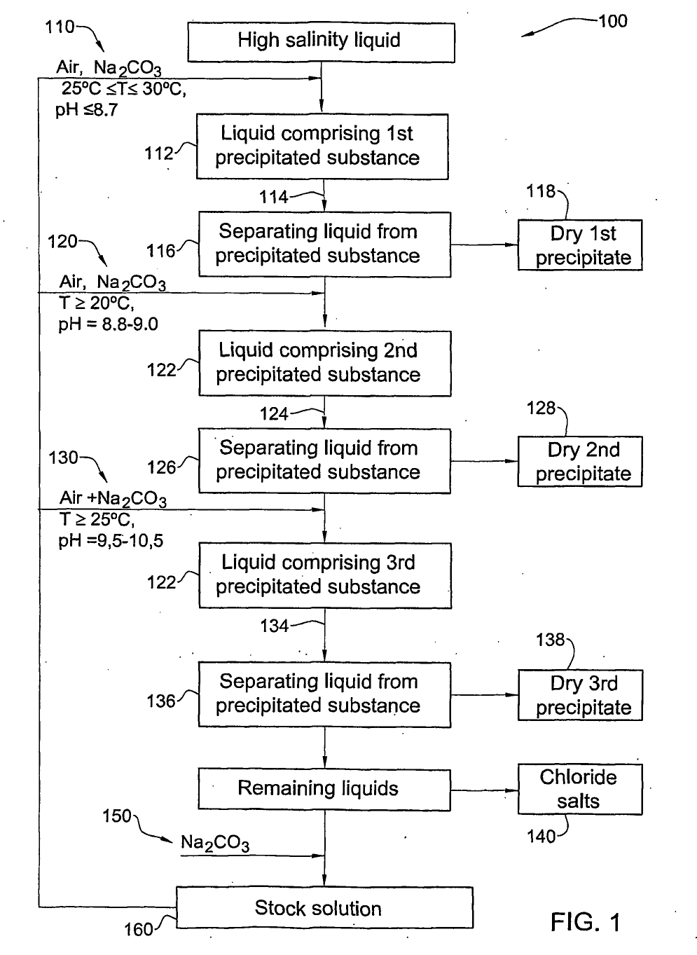

Reference is now made to FIG. 1 which provides a block diagram of the multi-stage process (100) for sequential recovery of different substances from high salinity liquid according to one embodiment disclosed herein.

As a 1^{st} treatment stage (the 1^{st} process conditions), high salinity liquid is fed with air and an amount of stock solution of Na₂CO₃ (Step 110). The introduction of pressured air forms turbulence in the liquid and thereby it's mixing. The temperature of the liquid is set to a range of 25° C. to 30° C. and the amount liquid Na₂CO₃ is added to reach an upper pH limit equal or below 8.7. Under these 1^{st} process conditions a precipitated substance is formed in the liquid (112). The precipitated liquid comprises an admixture of SrCO₃, BaCO₃, FeCO₃ and hydroxides of metals, such as Mn(OH)₂, Fe(OH)₂ and others. The substance comprises in its majority SrCO₃. The liquid including precipitated substance is withdrawn (114). From the removed liquid, SrCO₃ is pressed filtered (116) so as to separate from the liquid and the 1^{st} precipitated substance. The precipitated substance may then be washed and dried to a form ready for commercial use (118). It has been found that under these conditions it is possible to recover at least 95% w/w SrCO₃ from high salinity liquid.

The liquid form which SrCO₃ was removed is transferred to a 2^{nd} treatment stage (120) where an amount of stock solution of Na₂CO₃ is added concomitant with the introduction (e.g. bubbling or press injection) of air which also here causes the mixing of the liquid with the reagent, namely, with Na₂CO₃ (120). The temperature of the liquid is set to be above 20° C. and the amount of Na₂CO₃ is added to reach a pH in the range of 8.8-9.0. Under these conditions a 2^{nd} precipitated substance comprising high percentage of CaCO₃ is formed (122). Liquid comprising the precipitated substance is withdrawn (124). From the withdrawn liquid precipitated CaCO₃ is separated from the liquid, washed and dried to a form ready for commercial use (128). It has been found that under these conditions it is possible to recover at least 99% w/w CaCO₃ from high salinity liquid.

The liquid form which CaCO₃ was removed is then subjected to a 3^{rd} treatment stage (130). In this 3^{rd} stage, solution of Na₂CO₃ concomitant with the introduction of air (e.g. bubbling or air jets) is added to the treated liquid in an amount providing a pH in the range of 9.5-10.5 and at a temperature greater than 25° C., (130). As a result, a liquid including precipitated hydrates of magnesium carbonate (mainly, Magnesia Alba) is formed (132). Liquid comprising the precipitated substance is withdrawn (134). From the withdrawn liquid precipitated hydrates of magnesium carbonate, particularly, basic magnesium carbonate (Magnesia Alba) is separated from the liquid, washed and dried to a form ready for commercial use (138). The Magnesia Alba thus produced may also be further processed to form other magnesium-based products, such as MgO, Mg(OH)₂, MgCO₃ etc., as appreciated by those versed in the art. It has been found that the above multi stage process allows the recovery of the different substances in an essential high degree of purity, preferably, at least 99% w/w).

It is noted that the remaining liquid (after removal of Magnesia Alba) typically comprises chloride salts, such as NaCl, KCl, etc., and thus may be used for the production of NaCl and other chlorides (140). The remaining liquid may also be used to form the stock solution of Na₂CO₃. To this end, Na₂CO₃ is added to the remaining liquid (150), and the stock solution of Na₂CO₃ is thus formed (160). This stock solution is then introduced into the process as required (110, 120, 130).

It is noted that the process disclosed herein may be performed as a batch process as well as a continuous process. While a continuous process is a preferred mode of operation, those versed in the art will appreciate the technical modifications required in order to performed the process either way.

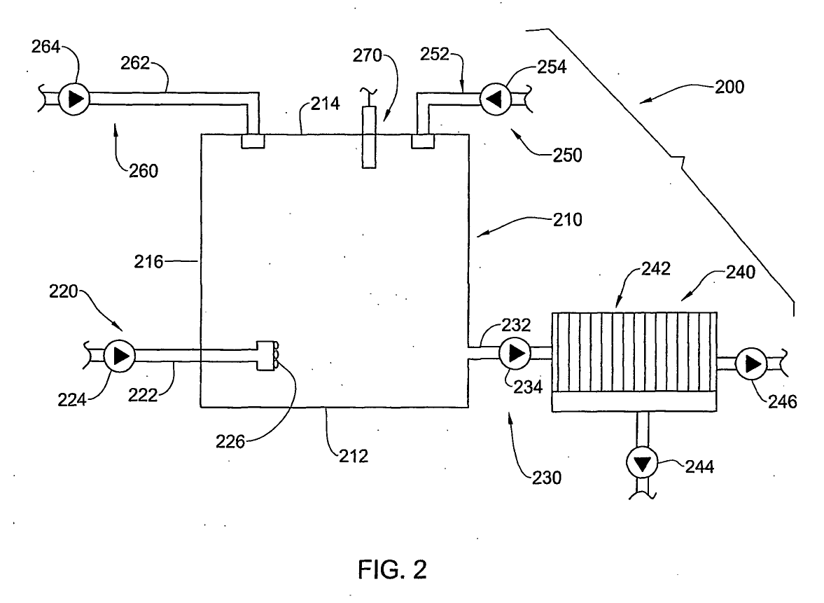

The process disclosed herein is preferably operated by the use of a Pachuca tank (Shekhar R and Evans J. W. Metallurgical Transactions B, Volume 20, Issue 6, pp. 781-791. (1989)). An alternative, albeit similar treatment unit for conducting the process disclosed herein is provided in FIG. 2.

FIG. 2 provides a simplified schematic illustration of a treatment unit generally designated 200 for recovery from high salinity liquid a substance comprising an alkaline earth carbonate. According to this non-limiting embodiment, treatment unit 200 comprises a liquid treatment module 210, which may be a tank (e.g. plastic tank) or any other suitable receptacle adapted for holding high salinity liquid. The liquid treatment module 210 has a bottom surface 212, top surface 214 and side walls 216. The top surface is preferably closed or essentially closed.

The liquid treatment module 210 is equipped with a gas supply assembly 220 for introducing gas, e.g. air, into the liquid held in said treatment module. The gas assembly is illustrated herein as comprising a conduit 222 and having at the end of the conduit disposed in the liquid within the treatment module 222 a multiplicity of gas supply nozzles 226 arranged along the gas supply conduit 222. The gas supply nozzles 226 receive and inject into the liquid gas under pressure from a pressurized gas source (not shown). To this end, the gas supply assembly may comprise a compressor 224 for compressing and injecting said gas into liquid held in the module 222. The gas supply assembly 220 may also be in the form of bubble diffusers connected to a source of pressurized gas. The introduction of gas under pressure causes turbulence in the liquid and thereby mixing of the liquid.

The liquid treatment module 210 is also equipped with a precipitate withdrawal assembly 230 for withdrawing liquid containing precipitated substances. The precipitate withdrawal assembly 230 comprises a conduit 232 connected to a pump 234 for pumping liquid comprising the precipitate from the treatment module. According to this embodiment, the precipitate withdrawal assembly 230 is positioned in proximity to the bottom surface 212 of liquid treatment module 210 so as to withdraw liquid from said bottom end 212.

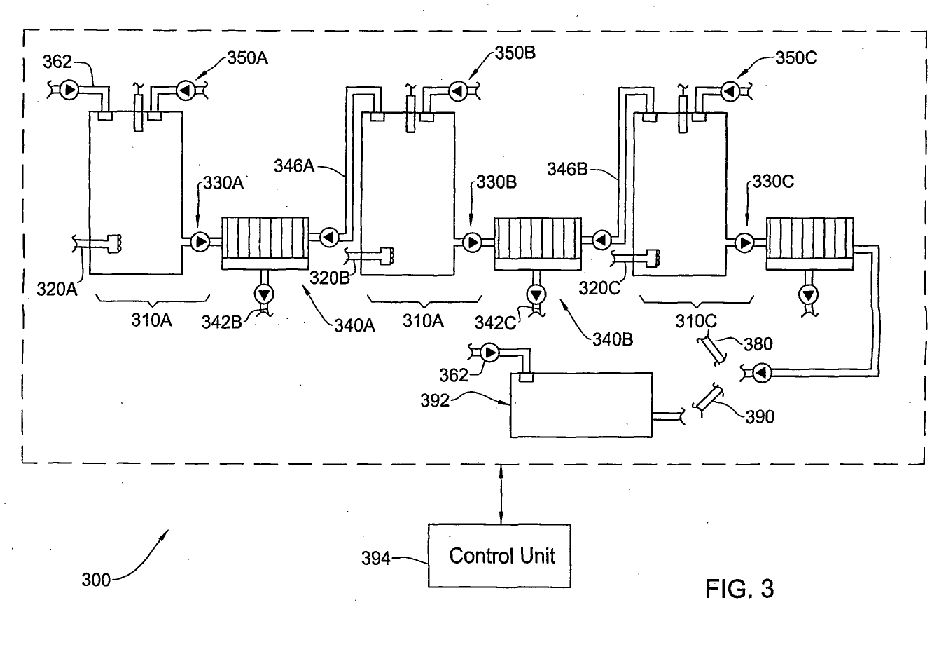

The liquid treatment module 210 is also equipped with a separation assembly 240 for separating precipitate from treated liquid and for communicating treated liquid from which the precipitated substance was removed to further processing in a subsequent treatment module (see as an example, FIG. 3) or any other receptacle (not shown). The separation assembly 240 extends from the precipitate withdrawal, assembly 230. The separation assembly 240 comprises a filter press device 242 as known to those versed in the art, and may be equipped with pump 244 for removing pressed precipitated substance and an additional pump 246 for pumping out filtered treated liquid.

The liquid treatment unit 200 also comprises a reagent supply assembly (250) for supplying and discharging a solution of alkali metal carbonate, e.g. Na₂CO₃, (the reagent) into the liquid held in said treatment module 210. The reagent supply assembly 250 comprises a conduit 252 for discharging the reagent into the treatment module 210. The conduit 252 may be connected to a pump 254 for pumping the reagent, from a source of the reagent (not shown) into the treatment module 210.

The liquid treatment unit 200 also comprises a liquid discharge assembly 260 comprising a conduit 262 for discharging fresh high salinity liquid into the liquid treatment module 210. The transfer of fresh liquid may utilize a pump 264.

The liquid treatment unit 200 may also comprise an environment control module 270 for e.g. monitoring and controlling the temperature or pH, of the liquid held in the treatment module 210 the reagent concentration in the liquid, for determining the concentration of a selected substance in the liquid, etc.

Each assembly in the context of the present disclosure may also be equipped with one or more valves for controlling fluid transfer therethrough. The opening and closure of the valves may be controlled manually or by a dedicated control unit, as depicted, for example, in FIG. 3.

Reference is now made to FIG. 3 which is a simplified schematic illustration of a high salinity treatment system in accordance with an embodiment of the invention and generally designated 300. For simplicity, like reference numerals to those used in FIG. 2, shifted by 100 are used to identify components having a similar function. For example, component 210 in FIG. 2 is a treatment module having the same function as treatment modules 310 in FIG. 3.

As can be seen in FIG. 3, the system comprises three separate treatment modules 310A, 310B and 310B, each representing a Pachuca tank or a treatment module similar to the treatment module illustrated in FIG. 2. The treatment units 310A, 310B and 310B are arranged in a series with liquid communication theirbetween. Initially, liquid is discharged into a 1^{st} treatment unit 310A via liquid discharge assembly 360, whereby a liquid comprising a 1^{st} precipitated substance, e.g. comprising SrCO₃, is produced according to a 1^{st} treatment conditions. It is noted that the liquid introduced into the 1^{st} treatment unit 310A may be pre-treated by electrolysis, to remove therefrom heavy and precious metals as described herein (not shown). The 1^{st} treatment unit 310A comprises an assembly for introducing reagent 350A, an assembly for introducing gas 320A, and a precipitate withdrawal assembly 330A for conveying liquid comprising the precipitated substance into a separation assembly 340A. In separation assembly 340A the 1^{st} precipitated substance is filtered out of the liquid via conduit 342A equipped with pump 344A. The 1^{st} precipitated substance may then be washed and dried (not shown). After separation between the 1^{st} precipitated substance and the liquid in the separation assembly 340A, the treated liquid, namely that filtered out in the separation assembly 340A, is conveyed via conduit 346A into a 2^{nd} treatment unit 310B. In this subsequent treatment unit 310B, a 2^{nd} precipitated substance, e.g. comprising CaCO₃, is produced under a 2^{nd} condition treatment as described herein, and liquid including the same is withdrawn from the treatment unit 310B via precipitate withdrawal assembly 330B into a subsequent separation assembly 340B. Similarly to FIG. 2, reagent is introduced into treatment unit 310B via assembly 350B. After separation between the 2^{nd} precipitate and the liquid in the separation assembly 340B, the precipitated substance is conveyed via conduit 342B for washing and drying. The conduit 342B may be equipped with a suitable pump 344B for facilitating withdrawal of the precipitated substance. The treated liquid, from which the 2^{nd} precipitated is removed, is conveyed via conduit 346B, into a 3^{rd} treatment unit 310C where a 3^{rd} precipitated substance, e.g. comprising Magnesia Alba, is produced. The 3^{rd} treatment unit 310C similarly comprises assemblies for introducing gas 320B, for introducing reagent 350C etc. The liquid including the precipitated substance is then withdrawn from the 3^{rd} treatment unit 310C via precipitate withdrawal assembly 330C into a 3^{rd} separation assembly 340C. The precipitated substance is conveyed for further processing via conduit 342C. In one embodiment, the precipitated substance is washed and dried and in another embodiment, the precipitated substance may be used for the production of other magnesium salts. The remaining liquid, typically comprising chloride salts may then be conveyed, via conduit 380 for recovery therefrom of chloride salts, such as NaCl. In addition, or alternatively, the remaining liquid may be used for producing the reagent's stock solution. To this end, the remaining liquid is conveyed, via conduit 390 into a unit 392 whereby the stock solution is prepared.

The high salinity treatment system 300 also comprises a control unit 394. The control unit is typically a computer system may comprise one or more of, inter alia a memory utility, a data processing and analyzing utility, a monitor, etc, and has appropriate operating utilities for generating operative signals for managing the operation of the modules and other components of the system.

As will readily be appreciated by the artisan, the above described specific embodiments are intended for illustrative purposes only of the much wider scope of the invention as defined above. As will further be appreciated, many routine modifications of these embodiments, as well as a large amount of other embodiments are possible and within the reach of an artisan applying ordinary skills in the art, within the general scope of the invention as defined herein.

As used in the specification and claims, the forms “a”, “an” and “the” include singular as well as plural references unless the context clearly dictates otherwise. For example, the term “an alkaline earth carbonate” includes one or more, of the same or different alkaline earth carbonates.

Further, as used herein, the term “comprising” is intended to mean that the treatment unit includes the recited elements, but not excluding others which may be optional in the design of the treatment unit, such as dedicated sensor, conduits, pumps etc. The term “consisting essentially of” is used to define an entity that include the recited elements but exclude other elements. For example, a substance consisting essentially of Magnesia Alba will not include or include only insignificant amounts of other salts. “Consisting of” shall thus mean excluding more than trace elements of other elements. Embodiments defined by each of these transition terms are within the scope of this invention.

Further, all numerical values, e.g. when referring the amounts or ranges of the elements constituting the process conditions, are approximations which are varied (+) or (−) by up to 20%, at times by up to 10% of from the stated values. It is to be understood, even if not always explicitly stated that all numerical designations are preceded by the term “about”.

### Description of Non-Limiting Examples

The process disclosed herein is based in principle on selective precipitation of various alkaline earth carbonate salts. In the following examples, the high salinity liquid was brine produced from one of the Israeli desalination plants

The following examples are based data derived from an Israeli Seawater Osmosis Plant which desalinates 300×10⁶ m³/year of sea water to produce 100×10⁶ m³/year of desalinated water and 116×10⁶ m³/year brine.

TABLE 1
Composition of seawater and brine produced at the
Israeli desalination Seawater Osmosis Plant.
Element (El), concentration (Con.) in sea water^{(a)} and brine^{(b)} (weight %)

| El | Con. % in Seawater | Con. % in Brine |
|---|---|---|
| Ag | 2.1 · 10⁻⁸ | 3.9 · 10⁻⁸ |
| Al | 3 · 10⁻⁶ | 5.6 · 10⁻⁶ |
| As | 1.1 · 10⁻⁶ | 2.0 · 10⁻⁶ |
| Au | 4 · 10⁻¹⁰ | 7.4 · 10⁻¹⁰ |
| B | 4.6 · 10⁻⁴ | 8.6 · 10⁻⁴ |
| Ba | 3 · 10⁻⁶ | 5.6 · 10⁻⁶ |
| Be | 6 · 10⁻¹¹ | 11.2 · 10⁻¹¹ |
| Bi | 2 · 10⁻⁸ | 3.7 · 10⁻⁸ |
| Br | 6.5 · 10⁻³ | 12.1 · 10⁻³ |
| C | 2.5 · 10⁻³ | 4.6 · 10⁻³ |
| Ca | 4 · 10⁻² | 7.4 · 10⁻² |
| Cd | 1.1 · 10⁻⁸ | 2.0 · 10⁻⁸ |
| Ce | 3.7 · 10⁻⁸ | 6.9 · 10⁻⁸ |
| Cl | 1.9 | 3.53 |
| Co | 7.5 · 10⁻⁸ | 13.9 · 10⁻⁸ |
| Cr | 5 · 10⁻⁹ | 9.3 · 10⁻⁹ |
| Cs | 1.5 · 10⁻⁷ | 2.8 · 10⁻⁷ |
| Cu | 8 · 10⁻⁷ | 14.9 · 10⁻⁷ |
| F | 1.2 · 10⁻⁴ | 2.2 · 10⁻⁴ |
| Fe | 2.1 · 10⁻⁶ | 3.9 · 10⁻⁶ |
| Ga | 2.6 · 10⁻⁸ | 4.8 · 10⁻⁸ |
| Ge | <0.5 · 10⁻⁷ | <0.9 · 10⁻⁷ |
| Hg | 3 · 10⁻⁹ | 5.6 · 10⁻⁹ |
| In | 2 · 10⁻⁸ | 3.7 · 10⁻⁸ |
| J | 5.3 · 10⁻⁶ | 9.8 · 10⁻⁶ |
| K | 3.8 · 10⁻² | 7.1 · 10⁻² |
| La | 3 · 10⁻⁸ | 5.6 · 10⁻⁸ |
| Li | 1.6 · 10⁻⁵ | 3.0 · 10⁻⁵ |
| Mg | 0.135 | 0.251 |
| Mn | 3.7 · 10⁻⁷ | 6.9 · 10⁻⁷ |
| Mo | 3.8 · 10⁻⁷ | 7.1 · 10⁻⁷ |
| N | 3.2 · 10⁻⁵ | 6.0 · 10⁻⁵ |
| Na | 1.057 | 1.966 |
| Nb | 1 · 10⁻⁹ | 1.9 · 10⁻⁹ |
| Ni | 1.7 · 10⁻⁷ | 3.2 · 10⁻⁷ |
| O | 86.14 | 86.15 |
| P | 5.7 · 10⁻⁶ | 10.6 · 10⁻⁶ |
| Pb | 3 · 10⁻⁷ | 5.6 · 10⁻⁷ |
| Pd | 2 · 10⁻⁹ | 3.7 · 10⁻⁹ |
| Pt | 1 · 10⁻¹¹ | 1.9 · 10⁻¹¹ |
| Ra | 0.9 · 10⁻¹⁴ | 1.7 · 10⁻¹⁴ |
| Rb | 1.7 · 10⁻⁵ | 3.2 · 10⁻⁵ |
| S | 8.8 · 10⁻² | 16.4 · 10⁻² |
| Sb | 5 · 10⁻⁸ | 9.3 · 10⁻⁸ |
| Sc | 4 · 10⁻⁹ | 7.4 · 10⁻⁹ |
| Se | 3 · 10⁻⁷ | 5.6 · 10⁻⁷ |
| Si | 1.8 · 10⁻⁴ | 3.3 · 10⁻⁴ |
| Sn | 3 · 10⁻⁷ | 5.6 · 10⁻⁷ |
| Sr | 1.1 · 10⁻³ | 2.0 · 10⁻³ |
| Th | 5.3 · 10⁻⁸ | 9.8 · 10⁻⁸ |
| Ti | 1 · 10⁻⁷ | 1.9 · 10⁻⁷ |
| Tl | <1 · 10⁻⁹ | 1.9 · 10⁻⁹ |
| U | 2 · 10⁻⁷ | 3.7 · 10⁻⁷ |
| V | 1.2 · 10⁻⁷ | 2.2 · 10⁻⁷ |
| W | 1 · 10⁻⁸ | 1.9 · 10⁻⁸ |
| Y | 3 · 10⁻⁸ | 5.6 · 10⁻⁸ |
| Zn | 2 · 10⁻⁶ | 3.7 · 10⁻⁶ |

^{(a)}Density of the sea water was 1.0277 t/m³, total salt concentration 3.95%;
^{(b)}Density of the brine is 1.06 t/m³, the salt concentration is 7.35%. The concentration of salts was increased 1.86 times.

An optional pre-treatment stage to the sequential, selective, precipitations disclosed herein comprises removal of precious and heavy metals. Accordingly, the pre-treatment stage includes introducing electrodes into the high salinity liquid, in this particular example, the brine, and subjecting the latter to electrolysis. To protect the cathodes, they are coated with a fabric impregnated with conducting paint on the basis of copper powder (the anodes are made of graphite). The electrolysis is carried at 25° C., voltage≦1.5 V and at a current density up to 10 A/m² of the cathode surface, while continuously bubbling air into the liquid. These parameters are selected so as to avoid electrolytic decomposition of water and of chlorides in the alkali metals with a separation on the cathodes of hydrogen and caustic alkalis, and of oxygen with chlorine on the anode.

Under these conditions, within 6 hours ˜80% of precious and heavy metals precipitate (as a mixed concentrate) on the cathode. It is noted that at temperature lower than 25° C., the duration of the electrolysis is prolonged, and at a temperature of >25° C. the duration of electrolysis shortened. The concentration of metals and the composition of the mixed concentrate are presented in Table 2.

TABLE 2
The quantity of heavy and precious metals and the composition of the concentrate
that can be produced from brine of the Israeli desalination plant
(Element (El); Concentration (Con. in weight %) in seawater^{(a)}
and brine^{(b)} (weight %); Quantity of element (Quant.))

| | | Quant in 1 m³ of | Quant separated | Quant. in | Quant. in |
|---|---|---|---|---|---|
| | Con. of El. | brine El % × | per year (El kg × | concentrate | concentrate |
| El | in brine % | 1.060 (Kg) | 116 × 10⁶ m³) | (weight %) | (oz) |
| Ag | 3.9 · 10⁻⁸ | 4.13 · 10⁻⁷ | 47.95 | 0.735 | 1541.8 |
| Au | 7.4 · 10⁻¹⁰ | 7.844 · 10⁻⁹ | 0.91 | 0.014 | 29.3 |
| Cu | 14.9 · 10⁻⁷ | 15.794 · 10⁻⁶ | 1832.1 | 28.076 | |
| Ni | 3.2 · 10⁻⁷ | 3.392 · 10⁻⁶ | 393.47 | 6.030 | |
| Co | 13.9 · 10⁻⁸ | 14.734 · 10⁻⁷ | 170.91 | 2.619 | |
| Cd | 2.0 · 10⁻⁸ | 2.12 · 10⁻⁷ | 24.6 | 0.377 | |
| In | 3.7 · 10⁻⁸ | 3.9 · 10⁻⁷ | 45.24 | 0.693 | |
| Sn | 5.6 · 10⁻⁷ | 5.94 · 10⁻⁶ | 689.0 | 10.559 | |
| Pb | 5.6 · 10⁻⁷ | 5.94 · 10⁻⁶ | 689.0 | 10.559 | |
| Hg | 5.6 · 10⁻⁹ | 5.94 · 10⁻⁸ | 6.9 | 0.106 | |
| As | 2.0 · 10⁻⁶ | 2.12 · 10⁻⁵ | 2459.2 | 37.686 | |
| Sb | 9.3 · 10⁻⁸ | 9.86 · 10⁻⁷ | 114.4 | 1.753 | |
| Bi | 3.7 · 10⁻⁸ | 3.9 · 10⁻⁷ | 45.24 | 0.693 | |
| Pd | 3.7 · 10⁻⁹ | 3.9 · 10⁻⁸ | 4.5 | 0.069 | 144.7 |
| Pt | 1.9 · 10⁻¹¹ | 2.0 · 10⁻¹⁰ | 0.02 | 0.0003 | 0.64 |
| Tl | 1.9 · 10⁻⁹ | 2.0 · 10⁻⁸ | 2.0 | 0.031 | |
| | | Total: | 6525.44 | 100.0 | |

In the extraction of ~80%, the weight of the concentrate will be 5520 kg/year

From the data presented in Table 2 it is evident that when using brine (form the Israeli desalination plant), it was possible to separate within a year 5220 kg concentrate of heavy and precious metal. In the purified brine there remained 1305.44 kg of heavy and precious metals.

After precipitating the metal on the protected cathode, the fabric was disposed or treated as described above so as to remove therefrom the precipitated metals and reuse of same. When using standard cathodes (not protected with a conducting fabric), they will need to be periodically treated so as to extract therefrom the metals. Various techniques are available for metal extraction, such as the copper smelting technique typically used in copper industry, which may be applied onto the cathodes periodically, e.g. once a month.

Table 3 shows that for extracting metals from brine, low electric power consumption is required.

TABLE 3
Electric power consumption for electrolytic isolation of metals
from brine (Element (El); gram/(A · hour); (A · hours)/year

| | | | Quantity of |
|---|---|---|---|
| | | | consumed electric |
| | | | power in the output |
| | Electrochemical | Quantity of separated | of electricity 50%, |
| El | equivalent, g/(A · h) | metals, kg/year | (A · h/year) |
| Ag | 4.025 | 47.95 | 23,826 |
| Au | 2.451 | 0.91 | 742 |
| Cu | 1.19 | 1832.1 | 3,079,160 |
| Ni | 1.1 | 393.47 | 715,400 |
| Co | 1.1 | 170.91 | 310,745 |
| Cd | 2.1 | 24.6 | 23,429 |
| In | 1.428 | 45.24 | 63,361 |
| Sn | 1.11 | 689.0 | 1,241,441 |
| Pb | 3.87 | 689.0 | 356,072 |
| Hg | 3.74 | 6.9 | 3,690 |
| As | 0.93 | 2459.2 | 5,288,602 |
| Sb | 1.52 | 114.4 | 150,526 |
| Bi | 2.6 | 45.24 | 34,800 |
| Pd | 1.99 | 4.5 | 4,523 |
| Pt | 1.82 | 0.02 | 22 |
| Tl | 2.55 | 2.0 | 1,570 |
| | Total: | 6,525.44 | 11,297,905 |

The calculation made in Table 3 was on the basis of the existing electrolytic equivalents at the output of metals in regard to the electric current of 50%, i.e. the consumption of electric power is assumed to be twofold as compared with the theoretically necessary quantity. In addition, the extraction of the metals is assumed to be equal to 80%. A qnalitative analysis confirmed the availability of gold, silver, copper, and other metals in the cathode product.

Specifically, at a voltage of 1.5V during electrolysis, the consumption of electric power is: W=1.5×11,297,905=16,946,858 W/h or 16,947 kWh. In other words, the pre-treatment provided means for cost effective isolation of precious or heavy metals from brine.

After the electrolytic pre-treatment step, the brine is pumped into a subsequent reactor, where the brine was further treated to sequentially recover therefrom carbonate salts at high purity level.

Specifically, the brine is subjected to a series of selective precipitation steps for the sequential recovery of high purity carbonate salts including SrCO₃, CaCO₃, and Magnesia Alba. The selective precipitation is based on the differences in the solubility limit of the different carbonates to be precipitated as will be elucidated below.

The reagent used for precipitating these carbonates is Na₂CO₃ dissolved in brine at a concentration of 270 g/liter brine. This solution is used as a stock solution for the subsequent precipitations.

### Preparation of Stock Solution of Na₂CO₃ (Also Known as Soda Ash Solution)

It is well appreciated that producing a stock solution of Na₂CO₃ with pure water will require later evaporation of a substantial amount of water, and thus, the inventor has envisaged that high salinity liquid per se may be used to prepare the stock solution.

According to the data of Table 1, the Na⁺ ion concentration in the initial brine of the example given herein was found to be 1.966% w/w, which at a brine density of d=1.06 g/cm³ was calculated to be 20.84 g/l of Na⁺. This quantity is equivalent to 52.96 g/l (kg/m³) of sodium chloride NaCl. During the extraction of all products by means of Na₂CO₃ in accordance with the present disclosure an additional quantity of sodium reaction is formed. Based on the amount of strontium in the brine (see Table 4), it was thus calculated that in order to precipitate strontium carbonate it is necessary to use 0.03 kg of Na₂CO₃ for 1 m³ of brine from the desalination plant; to precipitate the calcium carbonate, it is necessary to use Na₂CO₃ 2.1 kg/m³ of brine; while to precipitate Magnesia Alba, it is necessary to use 11.6 kg of Na₂CO₃ for 1 m³ of brine. The total consumption of Na₂CO₃ to precipitate all the products was thus calculated to be 13.73 kg/m³ of brine. An additional quantity of sodium chloride that will be obtained by the precipitation of all the products from the brine of the desalination plants was calculated to be 13.73×1.103=15.14 kg/m³ of NaCl; where 1.103 is the molecular weight ratio between sodium chloride and sodium carbonate:

$$K = \frac{M 2 NaCl 116.9}{M {Na}_{2} {CO}_{3} 106} 1.103$$

The total concentration of sodium chloride in the brine after precipitation is increased to 52.96+15.14=68.1 kg/m³, which is 6.4 weight % of NaCl. The chlorides solution of alkali metals that is purified of heavy metals, strontium, barium, magnesium and other admixtures that has a pH=10.5 is used to prepare a solution of Na₂CO₃. According to the data of mutual solubility in the Na₂CO₃—NaCl—H₂O system at a NaCl concentration of 6.4 weight %, the highest solubility of Na₂CO₃ was observed at temperatures of 30 to 35° C. and was 25.1 to 26.4 weight %.

Thus, to prepare a stock solution of Na₂CO₃, 266 kg of Na₂CO₃ are dissolved in 1 m³ of purified solution of alkali metal chlorides while stirring and at a temperature of ˜30° C. After a control filtration, the obtained stock solution of Na₂CO₃ contained 25.1 weight % of Na₂CO₃ (266 kg/m³) and was used to precipitate all the products, as described below. Using a stock solution of Na₂CO₃ from brine, allowed both to decrease the consumption of desalinated water, and to increase the NaCl concentration in the filtrate after the separation of all the products. Na₂CO₃, was also used to separate alkali metal chlorides (NaCl, KCl, LiCl, RbCl, CsCl), as well as to produce bromine and borates (e.g. borax Na₂B₄O₇.10H₂O) in accordance with the existing technologies.

### First Precipitate: SrCO₃

Brine is intensively air bubbled to which a solution of Na₂CO₃ was added until a pH of ≦8.7 was reached. The approximate amount of Na₂CO₃ added is equivalent to 105-110% of the stoichiometric amount that is needed for the precipitation of SrCO₃ (reaction (1) below). This amount was determined based on the solubility limit of SrCO₃ being 5.25×10⁻¹⁰ (gr·mole)/liter (at 25-30° C.), which is about 5 times lower than the solubility of CaCO₃ (solubility limit of CaCO₃ being 26.9×10⁻¹⁰ (gr·mole)/liter, thereby, permitting the selective precipitation of SrCO₃.

Without being bound by theory, it is assumed that the precipitation of SrCO₃ in the presence CaCO₃ is a result of the following equation (1):

SrCl₂+Na₂CO₃→SrCO₃+2NaCl (1)

The formation of carbon dioxide in the system prevents formation of SrCO₃. Accordingly, it has been envisaged by the inventor that active removal of the carbon dioxide from the system will increase SrCO₃ precipitation, and this removal was achieved by vigorous bubbling of air (or pure nitrogen or oxygen gas) into the system, which reduced the concentration of dissolved carbon dioxide.

Concomitant with the precipitation of SrCO₃, other carbonates with low solubility precipitated, such as BaCO₃, FeCO₃ having, respectively, solubility limits of 4×10⁻¹⁰ (gr·mole)/liter and 2.5×10⁻¹¹ (g·mole)/liter. These carbonates are prone to hydrolysis with the formation of metal hydroxides and carbon dioxide. One such hydrolysis may be represented by the following equation (2):

FeCO₃+H₂O→Fe(OH)₂+CO₂ (2)

Similarly, Mn(OH)₂ and other metal hydroxides precipitate with SrCO₃ as well as CaCO₃ (about 0.1%). Both Mn(OH)₂ and Fe(OH)₂ have very low solubility limit (respectively, 4.8×10⁻¹⁶ (g·mole)/liter and 4.0×10⁻¹⁴ (g·mole)/liter.

The composition of the first precipitate is provided in Table 4. As shown, the percentage of strontium carbonate in the first precipitate is >94.37% of SrCO₃. This concentrate may thus be an excellent product for utilization in glass industry, ceramic industry in the pyrotechnical and other industries.

TABLE 4
composition of matter in the first precipitate

| | | | Quantity of El | | Sort of | Conversion | Quantity of | | Content of |
|---|---|---|---|---|---|---|---|---|---|
| | El concentration | El quantity in | separated per | | precipitated | coefficient, | precipitated | | compound in the |
| El | in brine, weight % | 1 m³ of brine, kg | year, kg/t | | compound | compound/El | compound, kg/t | | concentrate, % |
| Sr | 2 · 10⁻³ | 2.12 · 10⁻² | 2,459.2 | tn | SrCO₃ | 1.685 | 4,143.7 | tn | 94.3784 |
| Ba | 5.6 · 10⁻⁶ | 6 · 10⁻⁵ | 6.96 | tn | BaCO₃ | 1.437 | 10.0 | tn | 0.2278 |
| Ca* | 7.4 · 10⁻⁵ | 7.84 · 10⁻⁴ | 90.944 | tn | CaCO₃ | 2.5 | 227.36 | tn | 5.1784 |
| Fe | 3.9 · 10⁻⁶ | 4.13 · 10⁻⁵ | 4.791 | tn | Fe(OH)₂ | 1.609 | 7.708 | tn | 0.1756 |
| Mn | 6.9 · 10⁻⁷ | 7.3 · 10⁻⁶ | 0.847 | tn | Mn(OH)₂ | 1.62 | 1.372 | tn | 0.0312 |
| Be | 11.2 · 10⁻¹¹ | 11.9 · 10⁻¹⁰ | 0.138 | kg | (BeO)₅CO₂•5H₂O | 5.75 | 0.795 | kg | 1.8 · 10⁻⁵ |
| Ce | 6.9 · 10⁻⁸ | 7.3 · 10⁻⁷ | 84.68 | kg | Ce₂(CO₃)₃ | 1.642 | 139 | kg | 3.2 · 10⁻³ |
| La | 5.6 · 10⁻⁸ | 5.9 · 10⁻⁷ | 68.44 | kg | La₂(CO₃)₃ | 1.648 | 112.8 | kg | 2.57 · 10⁻³ |
| Sc | 7.4 · 10⁻⁹ | 7.8 · 10⁻⁸ | 9.05 | kg | Sc(OH)₃ | 2.134 | 19.31 | kg | 4.4 · 10⁻⁴ |
| Y | 5.6 · 10⁻⁸ | 5.9 · 10⁻⁷ | 68.44 | kg | Y(OH)₃ | 1.524 | 107.7 | kg | 2.45 · 10⁻³ |

Total 4,390.5196 ton 100%
About 0.1% of the calcium contained in the brine was co-precipitated with strontium carbonate.
the quantity of brine is 116 · 10⁶ m³/year

In seawater and brine, calcium is contained mainly in the form of chloride CaCl₂, nonetheless, there are also insignificant quantities of calcium sulfate CaSO₄ and calcium bicarbonates Ca(HCO₃)₂. Table 1 shows that brine from the Israeli desalination plant contained 0.074 weight % of the Ca²⁺ ions, which correspond to 0.784 kg of Ca²⁺/m³ of brine. From this quantity of Ca²⁺ ions it is thus possible to produce 1.96 kg of CaCO₃/1 m³ of brine. Thus, from the brine of the Israeli desalination plant, by extraction at 98% it is possible to produce 222,800 ton of high-purity calcium carbonate.

### Second Precipitate: CaCO₃

The precipitation of CaCO₃ is carried out in the following manner:

The brine from which first precipitate is removed is heated to 60° C., while continuously mixing the system with air (bubbling air in) and an amount of the stock solution of Na₂CO₃ is added until reaching a pH≦8.8-9.0. The amount of stock solution added was calculated to provide 100% stoichiometric quantity to allow precipitation of Ca²⁺ in the form of CaCO₃. The mixing with air in the presence of the stock solution is carried out for one hour.

Without being bound by theory, it is assumed the following reactions occurred in the system:

CaCl₂+Na₂CO₃→CaCO₃+2NaCl;

CaSO₄+Na₂CO₃→CaCO₃+Na₂SO₄

Ca(HCO₃)₂+Na₂CO₃→CaCO₃+2NaHCO₃

2NaHCO₃→Na₂CO₃+CO₂↑+H₂O

The purification of the brine from calcium is carried out by more than 98.9%, because the solubility of carbon dioxide in water at a temperature of carrying out the process (≧60° C.) is decreased ˜3 times with 0.169 weight % at 20° C. to 0.058% at 60° C., and also the solubility of CO₂ is decreased even more to ≦0.01 weight %, because it was intensively removed by the bubbling of air. This accelerated the precipitation of CaCO₃.

It was also concluded by the inventor that the use of elevated temperature, namely, of ≧60° C. lowered the solubility of CaCO₃ (by about 4 times, (solubility limit of CaCO₃ at 25° C. being 38.9×10⁻¹⁰ (gr·mole)/liter, solubility limit of CaCO₃ at 60° C. being 9.55×10⁻¹⁰ g·mole/l).

After precipitation, the calcium carbonate was washed with water on a filter to remove the alkali metal chlorides and magnesium, and was dried at a temperature of 110-120° C. The CaCO₃ content in the washed precipitate was ≧99.96%. The washed CaCO₃ precipitate could thus be suitable for production of paper, rubber products, plastics, toothpastes and tooth powders, and other products. After purification from calcium compounds, the filtrate was conveyed for separation of the basic magnesium carbonate, namely, Magnesia Alba.

Third precipitate: 3MgCO₃.Mg(OH)₂.3H₂O

To precipitate the Magnesia Alba, the remaining liquid in the system was heated to a temperature ≧60° C. , while intensively bubbling in air and adding thereto an amount of stock solution of Na₂CO₃ to obtain pH=9.5 to 10.5. The amount of stock solution added was equivalent to 100% of the stoichiometric quantity that is necessary to carry out the following reaction:

4MgCl₂+4Na₂ CO₃+4H₂O→3MgCO₃.Mg(OH)₂.3_{H}₂O+CO₂↑+8NaCl

The stirring is carried out for 1 hour, which resulted in the precipitation of a basic magnesium carbonate (also known as Magnesia Alba (M.A.)). It is noted that the solubility of Magnesia Alba was decreased when the temperature of the system was increased. Accordingly, at 20° C. the solubility of M.A was 0.02 weight %, and the magnesium content was 26.6%.

At a Mg²⁺ ion content in brine of 0.251% (according to Table 1) it was calculated that in 1 m³ brine there are 2.66 kg of Mg²⁺ ions, and from this quantity it was concluded that from 1 m³ brine, 10 kg Magnesia Alba can be produced.

Further calculations show that at a Magnesia Alba solubility of 0.011 weight %, 0.11 kg of Magnesia Alba is dissolved in 1 m³ of brine. In the solid state it is thus possible to recover 10 kg-0.11 kg=9.89 kg, i.e. 98.9% (0.00989 ton/m³) of Magnesia Alba.

The precipitate was then thickened and filtered. The filtered product was then dried at 110-120° C. under vacuum conditions. The composition of the dry product comprised ≧99.9% 3MgCO₃.Mg(OH)₂.3H₂O. The Magnesia Alba thereby produced can be utilized as is or used to produce therefrom magnesium oxide and magnesium hydroxide, e.g. according to the following schematic reactions, the first being carried out at 800° C. and the second being carried out at pH=11.0:

3MgCO₃.Mg(OH)₂.3H₂O→4MgO+3CO₂↑+4H₂O

3MgCO₃.Mg(OH)₂.3H₂O+6NaOH→4Mg(OH)₂+3Na₂CO₃+3H₂O

After separating the Magnesia Alba, the filtrate was used in part, to form the stock solution of Na₂CO₃.

Table 1 shows that about 0.251% of magnesium are contained in the brine. When extracting all the magnesium in the form of basic carbonate, Magnesia Alba 3MgCO₃.Mg(OH)₂.3H₂O from the brine (from an Israeli desalination plant) it is calculated that it is possible to produce 116×10⁶×1.060×0.251%×3.757=1,159, 621 t, (where: 116×10⁶ m³=quantity of brine; 1.060 ton/m³ is the density of the brine; 0.251% is the Mg content in the brine; 3.757 is the coefficient showing the relation of the molecular weight of Magnesia Alba to the molecular weight of magnesium in the molecule)

1.-36. (canceled)

37. A process for recovering from high salinity liquid a substance comprising a selected alkaline earth carbonate, the process comprising:
(i) adding to said high salinity liquid a reagent comprising a solution of an alkali metal carbonate in an amount sufficient to allow precipitation of said substance in said liquid, while continuously introducing into the liquid a gas whereby a precipitated substance is formed in the liquid; and
(ii) isolating said precipitated substance from the liquid, said precipitated substance comprising at least 90% w/w of the selected alkaline earth carbonate.

38. The process of claim 37, wherein the amount of said reagent to be introduced into the liquid is determined based on one or more parameters selected from pH of the liquid, required pH for precipitation of the selected alkaline earth carbonate, temperature of the liquid, concentration in the liquid of the selected alkaline earth carbonate, solubility of the selected alkaline earth carbonate, concentration of the alkali metal carbonate in the reagent solution.

39. The process of claim 37, wherein said substance comprises an alkaline earth carbonate or hydrate thereof selected from the group consisting of SrCO₃, BaCO₃, CaCO₃, and xMgCO₃.yMg(OH)₂.zH₂O, wherein x, y and z represent the same or different stoichiometric coefficients.

40. The process of claim 37, wherein said reagent comprises a solution of Na₂CO₃.

41. The process of claim 37, comprising pre-treatment of said high salinity liquid to remove one or more metals from the liquid, said pre-treatment comprises subjecting the liquid to electrolysis, said electrolysis is carried out at a DC voltage equal or less than about 1.5V and to a current density equal or less than about 10 A/m².

42. The process of claim 37, wherein said electrolysis is carried out using protected cathode, said protection obtained by coating the cathode with a removable electric conducting material.

43. The process of claim 42, wherein said removable electric conducting material comprises a fabric coated or impregnated with conducting paint.

44. The process of claim 37, wherein said substance comprises one or more alkaline earth carbonate selected from SrCO₃, BaCO₃, FeCO₃, and said process comprises adding an amount of said reagent sufficient to obtain a pH in said liquid equal or less than 8.7 so as to permit precipitation of the one or more alkaline earth carbonate.

45. The process of claim 44, performed at a temperature of between about 25° C. and about 30° C.

46. The process of claim 37, wherein said substance comprising said alkaline earth carbonate is CaCO₃ and said CaCO₃ is recovered from the liquid after recovery therefrom of a substance comprising one or more of SrCO₃, BaCO₃, FeCO₃

47. The process of claim 46, comprising adding an amount of said reagent sufficient to obtain a pH in said liquid in the range of between about 8.8 to about 9.0 and at a temperature greater than 20° C. so as to permit precipitation of said CaCO₃.

48. The process of claim 37, wherein said substance comprises hydrate of Magnesium Carbonate of the general formula xMgCO₃.yMg(OH)₂.zH₂O where z, y and z are the same or difference stoichometric coefficients.

49. The process of claim 48, wherein said substance comprises Magnesia Alba and said process comprises adding an amount of said reagent sufficient to obtain a pH in said liquid in the range of between about 9.5 to about 10.5 and at a temperature greater than 25° C. so as to permit precipitation of the Magnesia Alba.

50. The process of claim 37 wherein steps (i) and (ii) are continuously repeated at a pH equal or less than 8.7 and at a temperature in the range of 25° C. to about 30° C. for sequential precipitation in a 1st process stage of substance comprising one or more alkaline earth carbonate selected from SrCO₃, BaCO₃, FeCO₃; at a pH between 8.8 and 9.0 and at a temperature greater than 20° C. for sequential precipitation of a substance comprising CaCO₃ in a 2^{nd} process stage; and at a pH of between about 9.5 to about 10.5 and at a temperature equal or greater than 25° C. for sequential precipitation of a substance comprising Magnesia Alba in a 3^{rd} process stage.

51. The process of claim 50, wherein said alkaline earth carbonate comprises essentially SrCO₃.

52. A treatment unit for recovery from high salinity liquid a substance comprising an alkaline earth carbonate, the unit comprising:
a liquid treatment module adapted for holding high salinity liquid and provided with an assembly for agitating the liquid held in said module;
an assembly for introducing a reagent of a solution of alkali metal carbonate into the liquid held in said treatment module;
a gas assembly for introducing gas into the liquid held in said treatment module;
precipitate withdrawal assembly for withdrawing liquid containing precipitated substances; and
an outlet for conveying liquid held in said treatment module.

53. A system for recovery from high salinity liquid a substance comprising an alkaline earth carbonate, the system comprising a plurality of treatment units according to claim 52, for precipitating and withdrawing a different substance, the system comprising a control unit for controlling the operation of the plurality of treatment units.

54. A system for recovery from high salinity liquid a substance comprising an alkaline earth carbonate, the system comprising a plurality of treatment units according to claim 52, for precipitating and withdrawing a different substance, the system comprising a control unit for controlling the operation of the plurality of treatment units.

55. The system of claim 53, wherein said plurality of treatment modules are arranged in a series, such that liquid removed from one treatment module is conveyed into a following treatment module, the system being constructed for operation as a continuous closed circuit system.

56. The system of claim 54, wherein said plurality of treatment modules are arranged in a series, such that liquid removed from one treatment module is conveyed into a following treatment module, the system being constructed for operation as a continuous closed circuit system.
